(19) United States
(12) Patent Application Publication
(10) Pub. No.: US 2007/0258719 A1
(43) Pub. Date: Nov. 8, 2007

(54) Remote Unit for Adding Frequency Assignments to a Separation-Type Base Transceiver Station

(75) Inventor: Jae Ick Lee, Gunpo-si Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited, Kyongki-do (KR)

(21) Appl. No.: 10/556,267

(22) PCT Filed: May 28, 2004
(86) PCT No.: PCT/KR04/01276

§ 371 Date: Mar. 5, 2007

(30) Foreign Application Priority Data
May 30, 2003 (KR) 10-2003-0034799

(51) Int. Cl. H04Q 7/30

(52) U.S. Cl. 398/115

(57) ABSTRACT

The present invention is related to a remote unit in a separation-type BTS, in which desired FA can be distributed and increased without additional changes. The remote unit comprises a main unit, an electro-optical converter for converting a signal transmitted from the main unit and received via an optical cable into an electric signal, a transceiver for processing the signals received and to be transmitted, a high power amplifier (HPA) for amplifying the transmission signal outputted from the transceiver, and a triplexer for sending the transmission signal outputted from the HPA to an antenna in a main path and setting up a path for a signal received from the antenna in the main path or an antenna in a diversity path. The remote unit further comprises an FA selection unit placed between the transceiver and the HPA for selecting a specific FA signal from the 3FA transmission signal outputted from the transceiver and sending it to the HPA, so that the FA can be easily increased.

### TECHNICAL FIELD

The present invention relates to a remote unit (RU) in a separation-type base transceiver station (BTS), in which the frequency assignment (FA) can be increased. In particular, it relates to an RU in a separation-type BTS, in which a desired FA can be distributed and increased without additional changes.

### BACKGROUND ART

In general, a separation-type BTS is used as a means for overcoming a shadowing area caused by the specific configuration of the ground, establishing an incipient network with lower costs, or overcoming spatial limitations (e.g., weight or size).

FIG. 1 is a block diagram of an overview of a conventional separation-type BTS. As shown in the drawing, the BTS comprises main unit (MU) 10, remote unit (RU) 20, optic cable 30 for communication between main unit 10 and remote unit 20.

FIG. 2 shows a configuration of main unit 10. As shown in the drawing, main unit 10 comprises channel card 11, BDCA 12, and DONOR 13 that comprises transceiver 13a for appropriately processing a transmission signal outputted from BDCA 12 and electro-optical converter 13b for converting the transmission signal outputted from transceiver 13a into an optical signal and sending it to optical cable 30.

Now the operation of main unit 10 will be described. First, a transmission signal outputted from channel card 11 is sent via BDCA 12 to DONOR 13. Transceiver 13a in DONOR 13 processes the transmission signal appropriately, and electro-optical transceiver 13b converts the processed transmission signal into an optical signal. The optical signal is transmitted via optical cable 30 to remote unit 20.

FIG. 3 is a block diagram that shows a configuration of an embodiment of remote unit 20. As shown in the drawing, remote unit 20 comprises electro-optical converter 21 for converting an optical signal received via optical cable 30 into an electric signal, transceiver 22 for appropriately processing the receive signal outputted from electro-optical converter 21 and appropriately processing a transmission signal to be outputted, high power amplifier (HPA) 23 for amplifying the transmission signal outputted from transceiver 22, and triplexer 24 for sending the transmission signal outputted from HPA 23 to antenna 25 and setting up a path for a signal from antenna 25 or antenna 26 for receiving a diversity signal.

Now the operation of remote unit 20 will be described.

First, electro-optical converter 21 receives an optical signal transmitted via optical cable 30 and converts it into an electric signal, and the transceiver appropriately processes the receive signal outputted from electro-optical converter 21.

Also, transceiver 22 appropriately processes a transmission signal to be outputted, and HPA 23 amplifies the transmission signal outputted from the transceiver 22 and sends it to triplexer 24.

Triplexer 24 sends the transmission signal outputted from HPA 23 to antenna 25, and switches a signal in a main path received via antenna 25 into a receive path.

Also, triplexer 24 performs a function to switch a signal received from antenna 26 for a diversity path into a receive path.

The main unit of the conventional separation-type BTS that operates as above is basically designed to output a 3FA IF signal, but it generates a 1FA signal that carriers presently demand. For carriers that design, establish and serve an incipient network, it is most ideal to establish the network with a system in a form that can accommodate all FAs (i.e., 3FA). However, it is difficult in reality to develop and establish a remote unit that can accommodate all FAs due to issues such as inviting subscribers, initial expenses invested, and technical difficulties in the design.

Therefore, carriers initially establish a network with a 1FA system, and later increase the FA in case of saturation in the network.

As for the remote unite that are now in use or about to be provided, there are two methods of increasing FA. One method is to use the present system (RU) with its output power lowered from 25W/1FA to 8.3W/1FA (in case of 3FA), and the other method is to replace the 1FA RU in service to a new RU that can accommodate 3FA.

However, the former method has a problem that the cell coverage for 25W/1FA is reduced by one-third and new cell planning is required.

Further, in the latter method, since the heat generated from the HPA cannot be overcome in a conventional RU, an additional heat exchanger, which is more than two or three times larger than the conventional one, a 120 W class HPA (or a linear power amplifier), or a power supply, which has power capacity increased by three times is required. Thus, there are many problems that should be technically resolved.

### DISCLOSURE OF THE INVENTION

The present invention is suggested to solve the above problems in the prior arts. The object of the present invention is to provide a remote unit in a separation-type BTS, in which a desired FA can be distributed and increased without additional changes.

To accomplish the object, an embodiment of a remote unit in a separation-type BTS in which an FA can be increased according to the present invention will be described.

A remote unit comprises an electro-optical converter for converting a signal transmitted from a main unit and received via an optical cable into an electric signal, a transceiver for processing the signals received and to be transmitted, a high power amplifier (HPA) for amplifying the transmission signal outputted from the transceiver, and a triplexer for sending the transmission signal outputted from the HPA to an antenna in a main path and setting up a path for a signal received from the antenna in the main path or an antenna in a diversity path.

The remote unit further comprises an FA selection unit placed between the transceiver and the HPA for selecting a specific FA signal from the 3FA transmission signal outputted from the transceiver and sending it to the HPA.

Further, to accomplish the object of the present invention, another embodiment of a remote unit in a separation-type BTS in which the FA can be increased according to the present invention will be described.

A remote unit comprises an electro-optical converter for converting a signal transmitted from a main unit and received via an optical cable into an electric signal, a transceiver for processing the signals received and to be transmitted, a high power amplifier (HPA) for amplifying the transmission signal outputted from the transceiver, and a triplexer for sending the transmission signal outputted from the HPA to an antenna in a main path and setting up a path for a signal received from the antenna in the main path or an antenna in a diversity path.

The remote unit further comprises an FA selection unit placed between the transceiver and the HPA for selecting a specific FA signal from the 3FA transmission signal outputted from the transceiver and sending it to the HPA, and an additional transceiver for sending a transmission FA signal outputted from the FA selection unit to an antenna after amplifying the signal and sending a receive signal received from the antenna to a receive path.

The additional transceiver comprises an HPA for amplifying a transmission FA signal outputted from the FA selection unit, and a duplexer for sending the amplified transmission signal to the antenna and sending a receive signal received from the antenna to a receive path.

### BRIEF DESCRIPTION OF DRAWINGS

FIG. 1 is a block diagram of an overview of a conventional separation-type BTS.

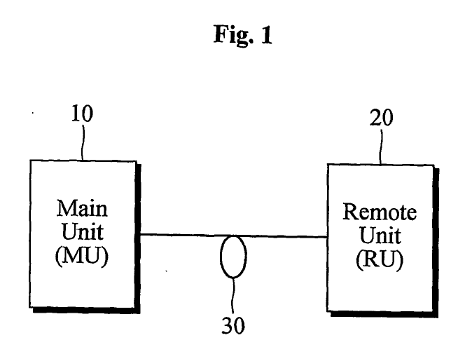

FIG. 2 shows an embodiment of the main unit in FIG. 1.

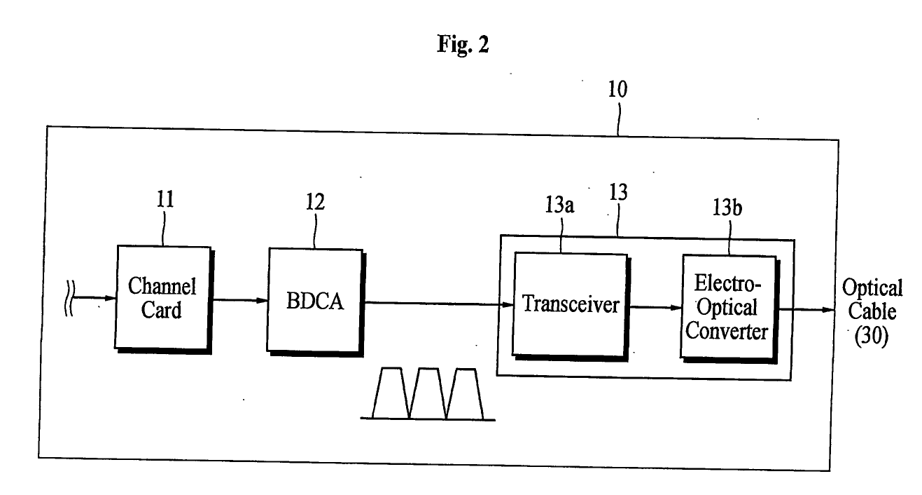

FIG. 3 shows an embodiment of the remote unit in FIG. 1.

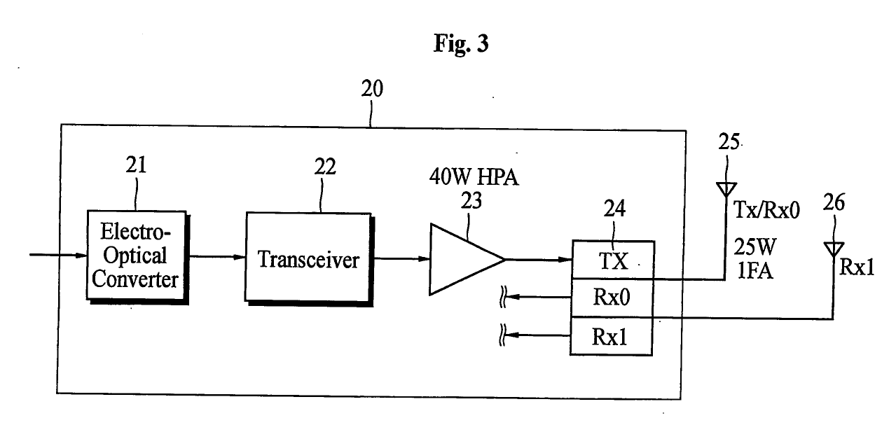

FIG. 4 is a block diagram that illustrates a configuration of a remote unit in a separation-type BTS in which an FA can be increased according to the present invention.

FIG. 5 is a diagram that explains the concept of selecting a frequency in an FA selection unit.

FIG. 6 is a block diagram that illustrates another configuration of a remote unit in a separation-type BTS in which FA can be increased according to the present invention.

### BEST MODE FOR CARRYING OUT THE INVENTION

The preferred embodiment of the present invention according to the above-mentioned technical features of the present invention is described below, together with drawings.

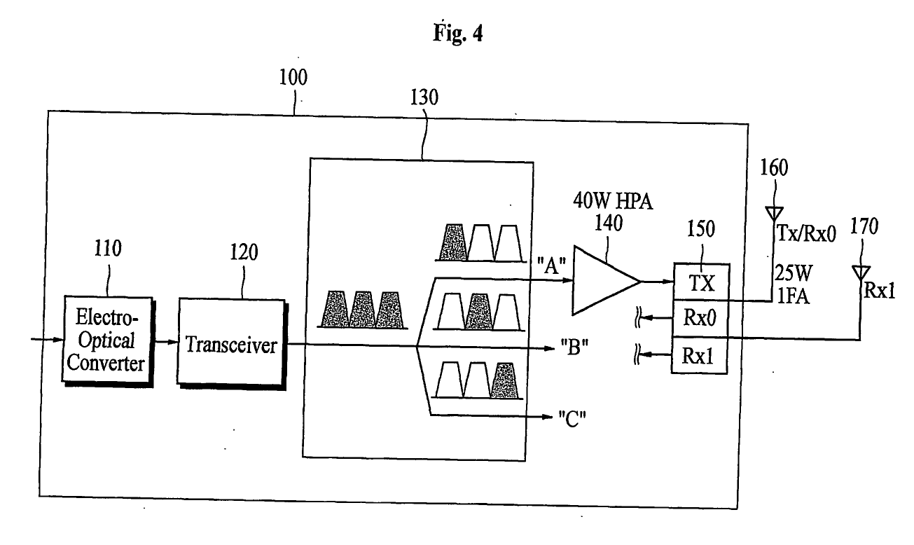

FIG. 4 is a block diagram that illustrates a configuration of a remote unit in a separation-type BTS in which FA can be increased according to the present invention. As shown in the drawing, remote unit 100 comprises electro-optical converter 110 for converting a signal transmitted from a main unit and received via an optical cable into an electric signal, transceiver 120 for processing the signals received and to be transmitted, FA selection unit 130 for selecting a specific FA signal from the 3FA transmission signal outputted from transceiver 120, high power amplifier (HPA) 140 for amplifying the specific FA transmission signal selected in FA selection unit 130, and triplexer 150 for sending the transmission signal outputted from HPA 140 to antenna 160 in a main path and setting up a path for a signal received from antenna 160 in the main path or antenna 170 in a diversity path.

The operation of the above remote unit in a separation-type BTS in which the FA can be increased according to the present invention will be described in detail.

First, electro-optical converter 110 receives a signal transmitted from the main unit via the optical cable and converts it into an electric signal, and transceiver 120 appropriately processes the received signal converted in electro-optical converter 110. Also, transceiver 120 outputs a transmission signal, which will be transmitted to the main unit, to FA selection unit 130.

FA selection unit 130 selects a specific FA signal from the 3FA transmission signal outputted from transceiver 120 and outputs it.

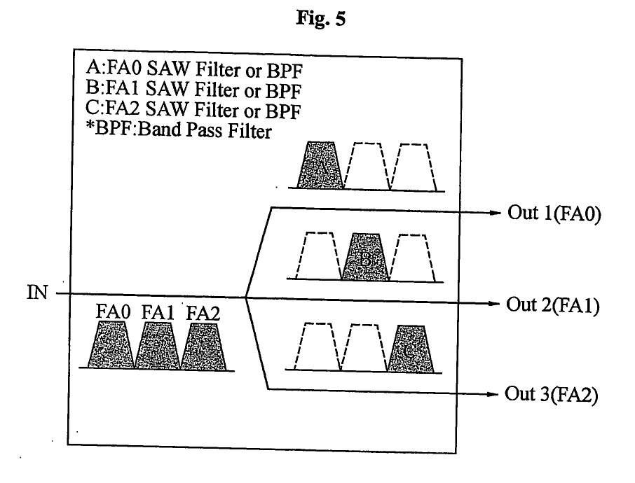

FIG. 5 is a diagram that illustrates internal operations of FA selection unit 130. As shown in the drawing, FA selection unit 130 comprises SAW (surface acoustic wave) filters to process respective frequency bands or band-pass filters (BPFs), and extracts three FA signals from the inputted 3FA signal and outputs them. Then, HPA 140 amplifies the specific FA transmission signal selected in FA selection unit 130 (e.g., FA0) and outputs it, and triplexer 150 sends the transmission signal outputted from BPA 140 to antenna 160 in the main path and sets up a path for a signal received from antenna 160 in the main path or antenna 170 in the diversity path.

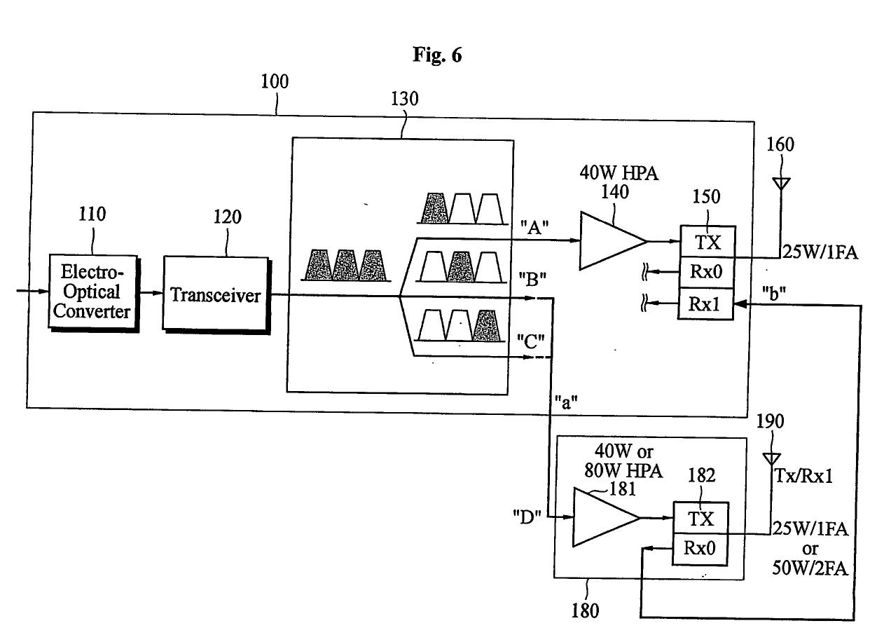

FIG. 6 is a block diagram that illustrates another configuration of a remote unit in a separation-type BTS in which FA can be increased according to the present invention. As shown in the drawing, remote unit 100 comprises electro-optical converter 110 for converting a signal transmitted from a main unit and received via an optical cable into an electric signal, transceiver 120 for appropriately processing the receive signal outputted from electro-optical converter 110 and appropriately processing a transmission signal to be transmitted to the main unit, FA selection unit 130 for selecting a specific FA signal from the 3FA transmission signal outputted from transceiver 120, high power amplifier (HPA) 140 for amplifying the specific FA transmission signal selected in FA selection unit 130, triplexer 150 for sending the transmission signal outputted from HPA 140 to antenna 160 and setting up a path for a signal received from antenna 160 or an antenna in a different path, and additional transceiver 180 for sending the transmission FA signal outputted from FA selection unit 130 to antenna 190 after amplifying the signal and sending a receive signal received from antenna 190 to a receive path.

Additional transceiver 180 comprises HPA 181 for amplifying transmission FA signal outputted from FA selection unit 130, and duplexer 182 for sending the transmission signal amplified in HPA 181 to antenna 190 and sending a receive signal received from antenna 190 to the receive path.

The operation of the above remote unit in a separation-type BTS in which FA can be increased according to the present invention will be described in detail.

First, electro-optical converter 110 receives a signal transmitted from the main unit via the optical cable and converts it into an electric signal, and transceiver 120 appropriately processes the receive signal converted in electro-optical converter 110. Also, transceiver 120 outputs a transmission signal to be transmitted to the main unit.

FA selection unit 130 selects a specific FA signal from the 3FA transmission signal outputted from transceiver 120 and outputs it. BPA 140 amplifies the transmission signal (e.g., FA0) outputted from FA selection unit 130.

Triplexer 150 sends the transmission signal outputted from HPA 140 to antenna 160 and sets up a path for a signal received from antenna 160 or an antenna in a different path.

After a carrier establishes a wireless network using FA0 or the desired FA with a power of 25W/1FA and begins wireless service in the initial stage, FA signal(s) will be distributed from the “B” or “C” point of FA selection unit 130 and processed if the FA needs to be increased (to 2FA or 3FA) due to increased subscribers.

That is, HPA 181 in additional transceiver 180 amplifies the transmission FA signal (e.g., FA1) outputted from FA selection unit 130, and duplexer 182 sends the transmission signal amplified in HPA 181 to antenna 190 and sends a receive signal received from antenna 190 to triplexer 150.

Additional transceiver 180 can be easily developed by adding existing modules (e.g., a duplexer or an HPA) without additional reformation. Moreover, there is no need to add a module in a backward link, so that the body of the RU can be reduced and the FA can be increased while using the advantages of the separation-type BTS.

Further, in case that the carrier wants to successively increase the FA from 1FA to 2FA and again to 3FA (with 25W/1FA), FA signal(s) can be distributed from the “B” or “C” point. In case that a direct increase from 1FA to 3FA occurs with the increased 2 FAs having lower power, the “B” and the “C” points can be combined to provide services with 12.5W/1 FA.

Of course, in all of the above cases, it is possible to provide services with only two antennas, like the initial 1FA service.

### INDUSTRIAL APPLICABILITY

According to the present invention described above, the carrier can flexibly increase the FAs as the subscribers increase without developing an additional system, by way of designing the separation-type BTS with the FA selection unit.

1. A remote unit in a separation-type BTS, comprising in which FA can be increased;
a main unit;
an electro-optical converter for converting a signal transmitted from the main unit and received via an optical cable into an electric signal;
a transceiver for processing the signals received and to be transmitted;
a high power amplifier (HPA) for amplifying the transmission signal outputted from the transceiver; and
a triplexer for sending the transmission signal outputted from the HPA to an antenna in a main path and setting up a path for a signal received from the antenna in the main path or an antenna in a diversity path,
characterized in that the remote unit further comprises an FA selection unit placed between the transceiver and the HPA for selecting a specific FA signal from the 3FA transmission signal outputted from the transceiver and sending it to the HPA.

2. The remote unit of claim 1, wherein the FA selection unit comprises three SAW filters for processing the 3FA signal in the respective frequency bands.

3. The remote unit of claim 1, wherein the FA selection unit comprises three BPFs for processing the 3FA signal in the respective frequency bands.

4. A remote unit in a separation-type BTS in which FA can be increased, comprising:
a main unit;
an electro-optical converter for converting a signal transmitted from the main unit and received via an optical cable into an electric signal;
a transceiver for processing the signals received and to be transmitted;
a high power amplifier (HPA) for amplifying the transmission signal outputted from the transceiver; and
a triplexer for sending the transmission signal outputted from the HPA to an antenna in a main path and setting up a path for a signal received from the antenna in the main path or an antenna in a diversity path,
characterized in that the remote unit further comprises an FA selection unit placed between the transceiver and the HPA for selecting a specific FA signal from the 3FA transmission signal outputted from the transceiver and sending it to the HPA, and an additional transceiver for sending the transmission FA signal outputted from the FA selection unit to an antenna after amplifying the signal and sending a receive signal received from the antenna to a receive path.

5. The remote unit of claim 4, wherein the additional transceiver comprises an HPA for amplifying a transmission FA signal outputted from the FA selection unit, and a duplexer for sending the transmission signal amplified in the HPA to the antenna and sending a receive signal received from the antenna to the receive path.
